(19) United States
(12) Patent Application Publication
(10) Pub. No.: US 2016/0313824 A1
(43) Pub. Date: Oct. 27, 2016

(54) CAPACITANCE CHANGE TRACKING CIRCUIT

(71) Applicant: Pixtronix, Inc., San Diego, CA (US)

(72) Inventor: Jasper Lodewyk Steyn, Campbell, CA (US)

(21) Appl. No.: 14/693,664

(22) Filed: Apr. 22, 2015

(51) Int. Cl. G06F 3/044

(52) U.S. Cl. CPC G06F 3/044

(57) ABSTRACT

This disclosure provides systems, methods and apparatus for a capacitance change tracking circuit. In one aspect, the capacitance change tracking circuit may determine a capacitance change associated with a display element including a movable element capable of positioning from a first position to a second position. The capacitance change tracking circuit may adjust an operating parameter of the display element based on the capacitance change. For example, the adjusted operating parameter may be an adjustment to an allocated time for the movable element to position from the first position to the second position or an adjustment to a voltage applied to an electrode of the display element.

### TECHNICAL FIELD

This disclosure relates to electromechanical systems and devices, and more specifically to a circuit to track a change in capacitance associated with display elements and adjusting an operating parameter of the display elements based on the change in capacitance.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

### SUMMARY

The systems, methods and devices of this disclosure each have several innovative aspects, no single one of which is solely responsible for the desirable attributes disclosed herein.

One innovative aspect of the subject matter described in this disclosure can be implemented in a circuit capable of determining a capacitance change associated with a display element including a movable element capable of positioning from a first position to a second position, and the circuit can further be capable of adjusting an operating parameter of the display element based on the capacitance change, adjusting the operating parameter of the display element including one or both of: adjusting an allocated time for the movable element to position from the first position to the second position, and adjusting a voltage applied to an electrode of the display element.

In some implementations, adjusting the voltage applied to the electrode of the display element can increase an amount of force used to position the movable element from the first position to the second position. In some implementations, the increase in the amount of force used to position the movable element from the first position to the second position can be capable of positioning the movable element from the first position to the second position within the allocated time. In some implementations, the circuit can be further capable of providing a signal to the display element, and the capacitance change can be determined based on a response of the display element to the signal. In some implementations, the signal can be a step voltage applied to a first electrode of the display element, and the response can be a transient current pulse associated with a second electrode of the display element.

In some implementations, the capacitance change can indicate that a capacitance associated with an actuator of the display element has decreased to a threshold value. In some implementations, the circuit can further be capable of adjusting a frequency of determining the capacitance change based on the capacitance change. In some implementations, the capacitance change can be associated with an accumulation of residue on an actuator of the display element.

In some implementations, the circuit can include a display including the display element; a processor capable of communicating with the display, the processor being capable of processing image data; and a memory device capable of communicating with the processor. In some implementations, the circuit can include a driver circuit capable of sending at least one signal to the display; and a controller capable of sending at least a portion of the image data to the driver circuit. In some implementations, the circuit can include an image source module capable of sending the image data to the processor, wherein the image source module can include at least one of a receiver, transceiver, and transmitter. In some implementations, the circuit can include an input device capable of receiving input data and communicating the input data to the processor.

Another innovative aspect of the subject matter described in this disclosure can be implemented in a display including an array of display elements, each display element in the array of display elements including a movable element capable of being positioned by an actuator; a capacitance change unit capable of determining a change in capacitance associated with the actuators; and a controller capable of adjusting an operating parameter of the array of display elements based on the change in capacitance, adjusting the operating parameter of the display elements including one or both of: adjusting an allocated time for the movable elements to position from the first position to the second position, and adjusting a voltage applied to electrodes of the display elements.

In some implementations, adjusting the voltage applied to the electrodes of the display elements can increase an amount of force used to position the movable elements from the first position to the second position. In some implementations, the increase in the amount of force used to position the movable elements from the first position to the second position can be capable of positioning the movable elements from the first position to the second position within the allocated time. In some implementations, each display element in the array of display elements can include a first electrode and a second electrode, and wherein the change in capacitance can be determined based on a signal applied to the first electrode of each display element and a response measured from the second electrode of each display element. Another innovative aspect of the subject matter described in this disclosure can be implemented in a method including determining a change in capacitance associated with a display element including a movable element capable of positioning from a first position to a second position; and adjusting an operating parameter of the display element based on the change in capacitance, adjusting the operating parameter of the display element including one or both of: adjusting an allocated time for the movable element to position from the first position to the second position, and adjusting a voltage applied to an electrode of the display element.

In some implementations, adjusting the voltage applied to the electrode of the display element can increase an amount of force used to position the movable element from the first position to the second position. In some implementations, the increase in the amount of force used to position the movable element from the first position to the second position can be capable of positioning the movable element from the first position to the second position within the allocated time. In some implementations, the method can include applying a signal to a first electrode of the display element, and wherein determining the change in capacitance can be based on a response of a second electrode of the display element to the signal.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3 shows a schematic diagram of an example display module that includes three transistors and a display element.

FIG. 4A shows an example of applying voltages to terminals of a display element.

FIG. 4B shows an example of positioning a shutter of a display element based on voltages applied to the terminals of the display element.

FIG. 5 shows a schematic diagram of an example capacitance change tracking circuit.

FIGS. 6A and 6B show charts of examples of current measurements for capacitance change tracking.

FIGS. 7A, 7B, 7C and 7D show examples of adjusting operating parameters of a display element based on the capacitance change.

FIGS. 8A and 8B show examples of adjusting operating parameters of the capacitance change tracking based on the capacitance change.

FIGS. 9A and 9B show examples of adjusting a number of display elements measured at a time.

FIG. 10 shows a flowchart of an example process flow for adjusting operating parameters of a display element based on a change in capacitance.

FIGS. 11A and 11B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, a display element can operate within a liquid. However, the liquid may break down as electric fields are generated upon the operation of the display element, and residue may accumulate on the display element's actuators. The accumulation of residue can interfere with the expected operation of the display element. For example, the display element may operate slower than expected due to the accumulated residue.

A capacitance change tracking circuit can determine a change in capacitance of an actuator of a display element associated with the residue accumulating on the actuators. The operating parameters of the display element (such as voltages or timing considerations) may be adjusted based on the change in capacitance. Accordingly, as the residue accumulates on the actuators, the operating parameters of the display element may be adjusted such that the display element operates as expected.

Particular implementations of the subject matter described in this disclosure can be implemented to realize one or more of the following potential advantages. Adjusting operating parameters of the display element as residue is accumulated on an actuator may maintain a properly-functioning display. The operating parameters also may be adjusted to compensate for environmental changes and actuator distortion. For example, temperature, humidity, radiation, and other environmental changes may result in the operating parameters to change to maintain a properly-functioning display. As another example, some actuators may distort, or deform from an expected shape or size, due to process variations (during fabrication), naturally over time, or use out of official specifications, and therefore, operating parameters may be changed to account for the distortion. Additionally, the lifetime of the display may be lengthened.

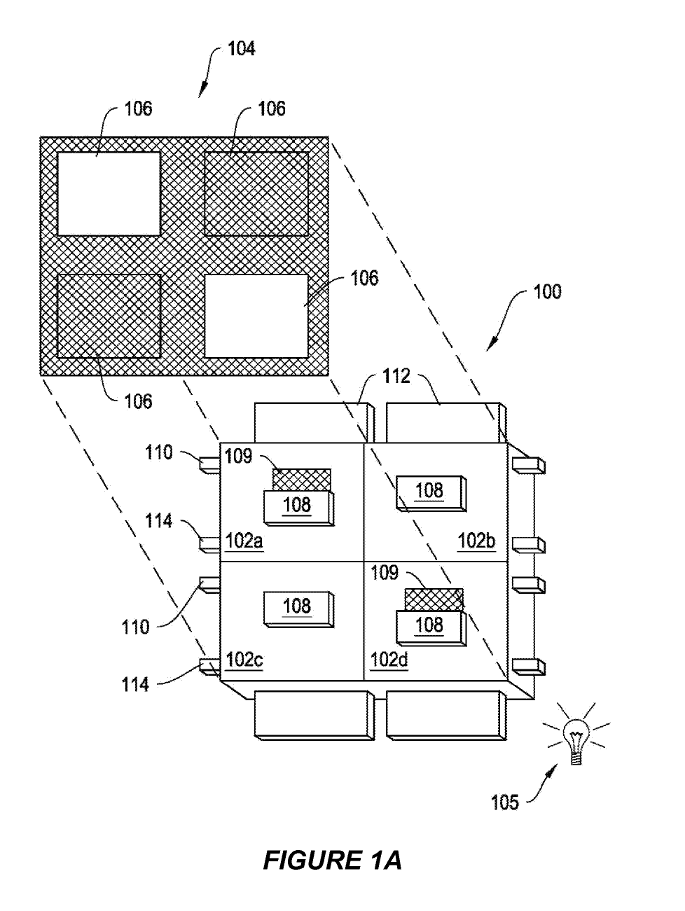

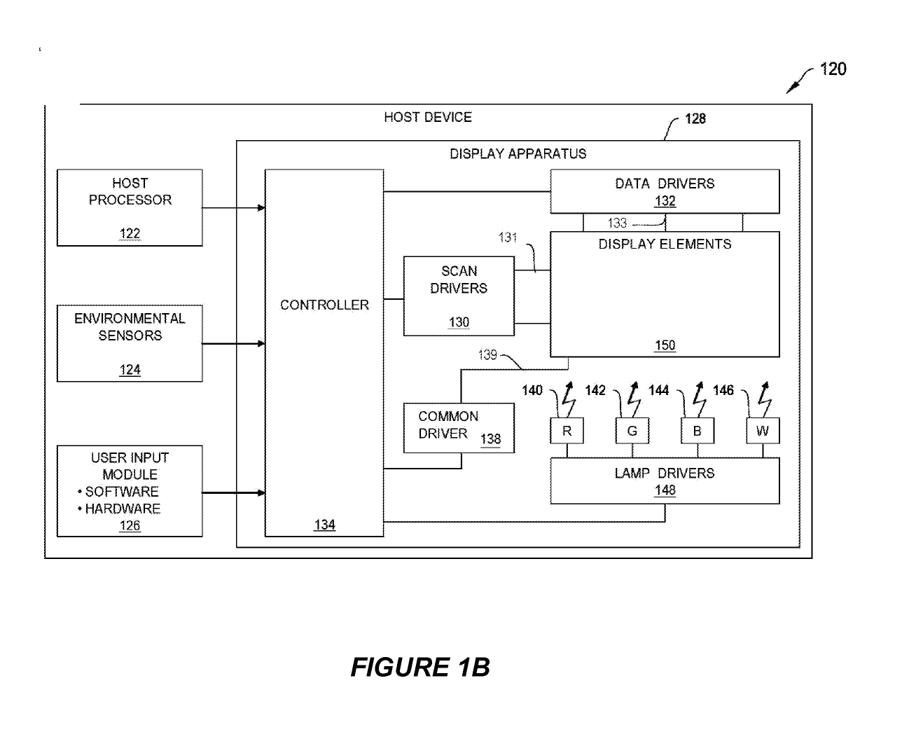

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

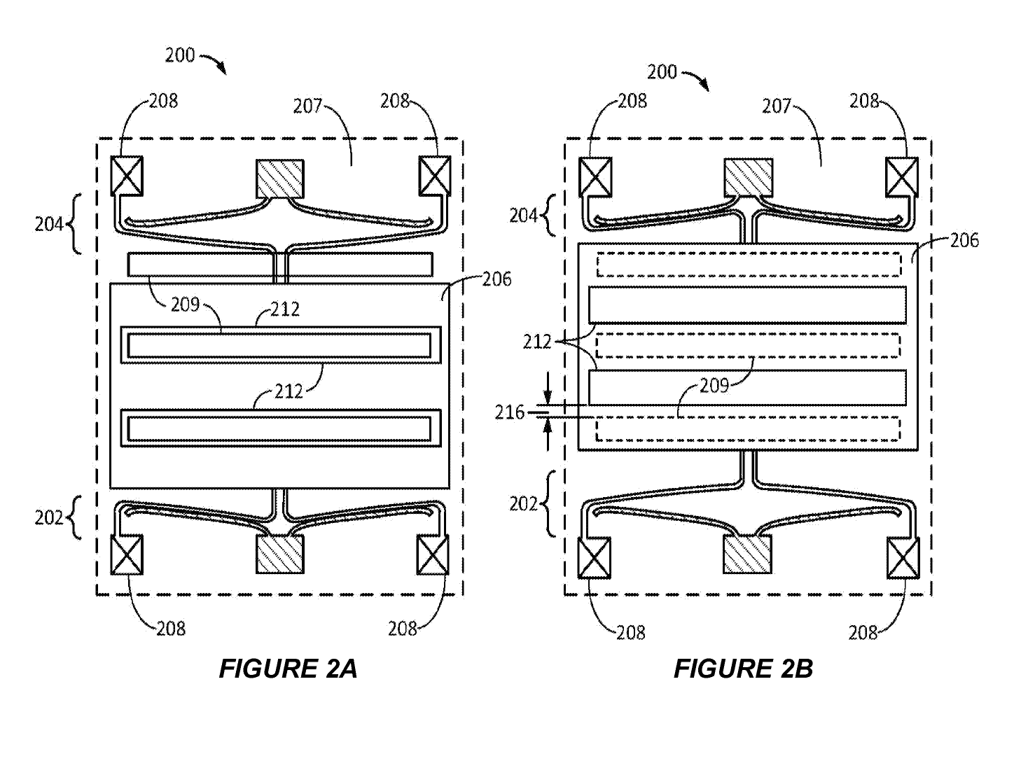

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

Electrical bi-stability in electrostatic actuators, such as actuators 202 and 204, can arise from the fact that the electrostatic force across an actuator is a function of position as well as voltage. The beams of the actuators in the shutter assembly 200 can be implemented to act as capacitor plates. The force between capacitor plates is proportional to 1/d² where d is the local separation distance between capacitor plates. When the actuator is in a closed state, the local separation between the actuator beams is very small. Thus, the application of a small voltage can result in a relatively strong force between the actuator beams of the actuator in the closed state. As a result, a relatively small voltage, such as Vₘ, can keep the actuator in the closed state, even if other elements exert an opposing force on the actuator.

In dual-actuator light modulators, the equilibrium position of the light modulator can be determined by the combined effect of the voltage differences across each of the actuators. In other words, the electrical potentials of the three terminals, namely, the shutter open drive beam, the shutter close drive beam, and the load beams, as well as modulator position, can be considered to determine the equilibrium forces on the modulator.

For an electrically bi-stable system, a set of logic rules can describe the stable states and can be used to develop reliable addressing or digital control schemes for a given light modulator. Referring to the shutter assembly 200 as an example, these logic rules are as follows:

Let Vₛ be the electrical potential on the shutter or load beam. Let Vₒ be the electrical potential on the shutter-open drive beam. Let V_{c} be the electrical potential on the shutter-close drive beam. Let the expression |Vₒ−Vₛ| refer to the absolute value of the voltage difference between the shutter and the shutter-open drive beam. Let Vₘ be the maintenance voltage. Let Vₐₜ be the actuation threshold voltage, i.e., the voltage to actuate an actuator absent the application of Vₘ to an opposing drive beam. Let Vₘₐₓ be the maximum allowable potential for Vₒ and V_{c}. Let Vₘ<Vₐₜ<Vₘₐₓ. Then, assuming Vₒ and V_{c} remain below Vₘₐₓ:

If |Vₒ−Vₛ|<Vₘ and |V_{c}−Vₛ|<Vₘ (rule 1)

Then the shutter will relax to the equilibrium position of its mechanical spring.

If |Vₒ−Vₛ|>Vₘ and |V_{c}−Vₛ|>Vₘ (rule 2)

Then the shutter will not move, i.e., it will hold in either the open or the closed state, whichever position was established by the last actuation event.

If |Vₒ−Vₛ|>Vₐₜ and |V_{c}−Vₛ|<Vₘ (rule 3)

Then the shutter will move into the open position.

If |Vₒ−Vₛ|<Vₘ and |V_{c}−Vₛ|>Vₐₜ (rule 4)

Then the shutter will move into the closed position.

Following rule 1, with voltage differences on each actuator near zero, the shutter will relax. In many shutter assemblies, the mechanically relaxed position is partially open or closed, and so this voltage condition is usually avoided in an addressing scheme.

The condition of rule 2 makes it possible to include a global actuation function into an addressing scheme. By maintaining a shutter voltage which provides beam voltage differences that are at least the maintenance voltage, Vₘ, the absolute values of the shutter open and shutter closed potentials can be altered or switched in the midst of an addressing sequence over wide voltage ranges (even where voltage differences exceed Vₐₜ) with no danger of unintentional shutter motion.

The conditions of rules 3 and 4 are those that are generally targeted during the addressing sequence to ensure the bi-stable actuation of the shutter.

The maintenance voltage difference, Vₘ, can be designed or expressed as a certain fraction of the actuation threshold voltage, Vₐₜ. For systems designed for a useful degree of bi-stability, the maintenance voltage can exist in a range between about 20% and about 80% of Vₐₜ. This helps ensure that charge leakage or parasitic voltage fluctuations in the system do not result in a deviation of a set holding voltage out of its maintenance range—a deviation which could result in the unintentional actuation of a shutter. In some systems, an exceptional degree of bi-stability or hysteresis can be provided, with Vₘ existing over a range of about 2% and about 98% of Vₐₜ. In these systems, however, care must be taken to ensure that an electrode voltage condition of |V_{c}-Vₛ| or |Vₒ−Vₛ| being less than Vₘ can be reliably obtained within the addressing and actuation time available.

In some implementations, the first and second actuators of each light modulator are coupled to a latch or a drive circuit to ensure that the first and second states of the light modulator are the two stable states that the light modulator can assume.

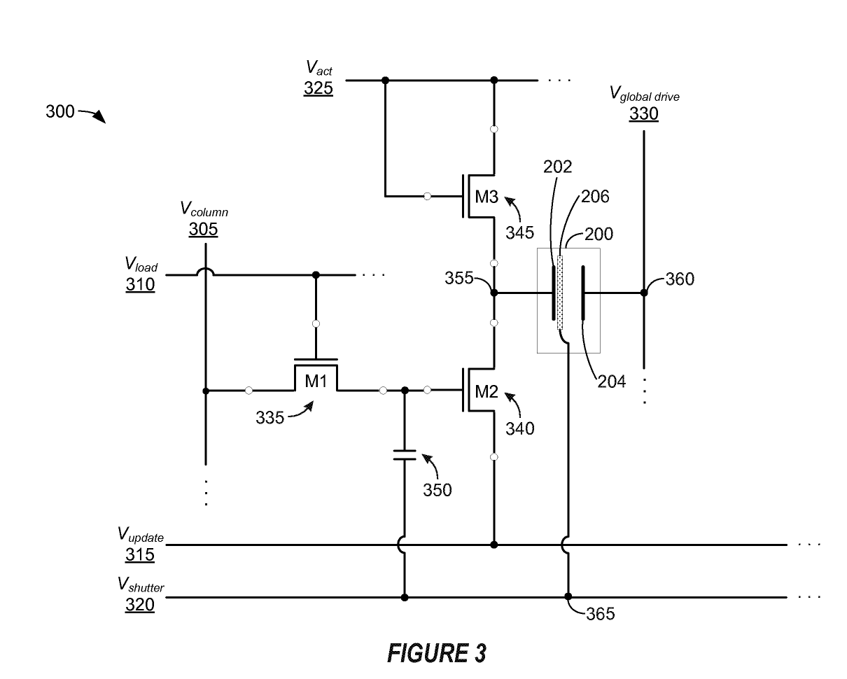

FIG. 3 shows a schematic diagram of an example display element that includes three transistors. Generally, in FIG. 3, display module 300 includes nodes 355, 360, and 365 that may be biased with voltages to drive electrodes of a display element, such as a light modulator as depicted in FIG. 1A, including shutter assembly 200, as depicted in FIGS. 2A and 2B, such that actuators 202 and 204 position a movable element such as shutter 206 to a particular position by addressing transistors M1 335, M2 340, and M3 345 in FIG. 3, and charging or discharging capacitor 350 using a drive scheme including an application of voltages on V_{column} 305, V_{load} 310, V_{update} 315, Vₛₕᵤₜₜₑᵣ 320, V_{act} 325, and V_{global drive} 330, which may be provided by data drivers 132, scan drivers 130, and common driver 138 of FIG. 1B. For example, node 355 may provide a voltage for an electrode associated or coupled with actuator 202, node 360 may provide a voltage for an electrode associated or coupled with actuator 204, and node 365 may provide a voltage for an electrode associated or coupled with shutter 206. As a result, shutter 206 of shutter assembly 200 can be moved to the open or closed positions (or states) by actuators 202 and 204 based on the voltages applied to nodes 355, 360, and 365.

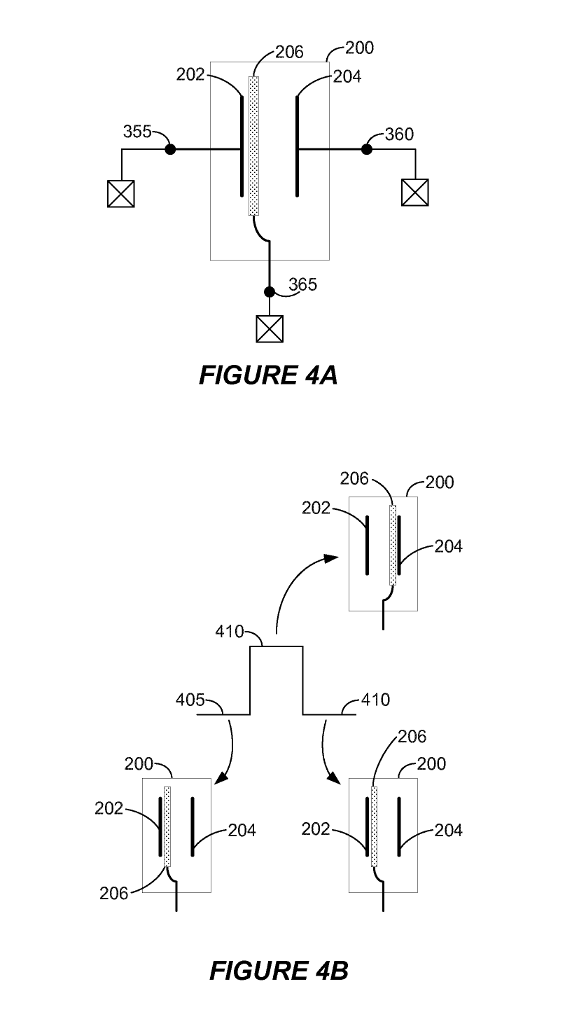

Any display module scheme allowing for voltages to be applied to the terminals of a display element may be used. For example, the circuit in FIG. 3 may be used, but other circuits with different drive schemes and interconnections between components and sources may be used. FIG. 4A shows an example of applying voltages to terminals of a display element. In FIG. 4A, as voltages are applied to nodes 355, 360, and 365, shutter 206 of shutter assembly 200 of a display element may be positioned between actuators 202 and 204 to provide open or closed positions, as previously discussed. For example, in FIG. 4A, shutter 206 is positioned closer to actuator 204. If shutter 206 was to be positioned closer or towards actuator 206, the voltages at one or more of nodes 355, 360, and 365 may need to be changed such that the electric fields generate a proper amount and direction of force on the actuators to position shutter 202 closer or towards actuator 204.

Additionally, shutter 206 in FIG. 4A may need to be moved to the position closer or towards actuator 204 within a particular time frame in order to meet timing requirements. For example, as previously discussed, in a field sequential color method, each color of an image frame may have its own subframe. A first subframe may have a shutter 206 in the open position, but a subsequent, second subframe may have the same shutter 206 in the closed position, and a third subframe following the second subframe may have the same shutter 206 back in the open position. Shutter 206 may be given a certain amount of time to position from open-to-close or close-to-open. That is, shutter 206 may have an allotted, or allocated, time it is expected to be able to move to any other position within its movement range as it positions properly for each subframe. The voltages applied to nodes 355, 360, and 365 may be selected such that the magnitude of the electric fields generated can provide enough force to position shutter 206 of the display element to the proper position within the allotted time.

For example, for the first subframe, controller 134, as depicted in FIG. 1B, may provide data to data drivers 132, scan drivers 130, and common driver 138 such that shutter 206 may be positioned to the open position, as depicted in FIG. 2A. Next, for the second subframe, controller 134 may provide data to data drivers 132, scan drivers 130, and common driver 138 such that shutter 206 may next be positioned to the closed position, as depicted in FIG. 2B. Generally, controller 134 may provide the data to transition shutter 206 from the open position in the first subframe to the closed position in the second subframe after the allotted time such that shutter 206 was in the proper position and for a proper duration in the first subframe before switching to the new position in the second subframe. For example, a clock signal may be used to ensure that the data is provided at a proper rate.

Accordingly, the selection of voltages to apply to nodes 355, 360, and 365 and the allotted time shutter 206 is expected to move to a new position may be operating parameters of shutter assembly 200 of a display element. The operating parameters affect the performance of the display element by affecting the movement of shutter 206 by actuators 202 and 204.

In some implementations, shutter assembly 200 can operate in silicon oil or in another liquid or in a gas (such as air). In a liquid, as the voltages are applied to the three electrodes of shutter assembly 200 (by biasing nodes 355, 360, and 365 in FIGS. 3 and 4A) to position shutter 206, electric fields are generated between the electrodes and across the liquid. However, the liquid can break down as the electric fields are applied and residue may accumulate on actuators 202 or 204. The accumulated residue can increase the gap between the actuators 202 and 204, and therefore, decrease their capacitance. This may reduce the magnitude of the electric fields, which may result in a lower force used to move actuators 202 and 204 and position shutter 206. As a result, the display element may operate slower (such as take more time to position shutter 206 from an open position to a closed position, and vice versa) or higher voltages may need to be applied to one or more of the electrodes to position shutter 206 within the proper timing requirements. For example, if 15 V is applied to node 355, 0 V is applied to node 360, and 0 V is applied to node 365, the magnitude of the electric fields (and therefore the force) from that application of voltages may be lower in a situation with an accumulation of residue on the actuators than in a situation with the same application of voltages but without the accumulation of residue. Accordingly, the accumulation of residue can interfere with the expected operation of shutter assembly 200 of display module 300. Residue also may accumulate on actuators 202 and 204 if a gas is used.

Moreover, environmental changes also may interfere with the expected operation of shutter assembly 200. For example, changes in temperature, humidity, radiation, and other environmental factors may affect the operation of shutter assembly 200. Distortion of actuators 202 or 204 also may interfere with the expected operation of shutter assembly 200. For example, process variations may cause actuators 202 or 204 to be slightly different between shutter assemblies 200. Distortion also may occur in some actuators 202 or 204 due to use over an extended period of time or use outside of official specifications (such as “overclocking” a display).

In some implementations, a capacitance change tracking circuit can determine a change in capacitance of an actuator of shutter assembly 200 due to the accumulating residue (or environmental changes or distortion). The operating parameters (such as voltages applied to one or more of nodes 355, 360, and 365, or the allotted time for shutter 206 to be positioned, as previously discussed regarding FIG. 4A) of the array of display elements 150 (including shutter assemblies 200) may be adjusted based on the change in capacitance. Accordingly, as the residue accumulates on the actuators, the operating parameters of the array of display elements 150 may be adjusted such that the display operates as expected and the lifetime of the display can be extended.

In some implementations, in order to determine the capacitance of an actuator of a shutter assembly 200, a step voltage may be applied to one of the electrodes of each shutter assembly 200 in the array of display elements 150. For example, in FIG. 4A, if node 355 is biased at 15 V (i.e., applying 15 V to the electrode associated with actuator 202) and node 360 is biased at 0 V (i.e., applying 0 V to the electrode associated with actuator 204), a step voltage may be applied to node 365 (i.e., the step voltage may be applied to the electrode associated with shutter 206) to position shutter 206 within its movement range. As shutter 206 moves within its movement range between actuators 202 and 204, a transient current pulse based on the capacitance may be generated at the electrodes (such as the electrode associated with actuator 204). For example, as an actuator's capacitance decreases (due to the accumulation of residue on actuators 202 or 204), the peak current of the transient current pulse also may decrease. Thus, a measurement of the peak current of the transient current pulse may be used as an indirect measurement of the capacitance. Multiple measurements of the capacitance (by applying the step voltage multiple times and measuring the peak currents of the transient current pulses) may be made and recorded to determine how much the capacitance has changed over time.

FIG. 4B shows an example of positioning a shutter of a display element based on voltages applied to the terminals of the display element. If node 355 in FIG. 4A is biased at 15 V, node 360 is biased at 0 V, and node 365 is provided a step voltage ranging from 0 V to 15 V, then shutter 206 may be positioned through its movement range and the transient current pulse may be generated. For example, at time 405 in FIG. 4B, shutter 206 of shutter assembly 200 may be positioned closer to actuator 202 because the voltage applied to node 365 at time 405 would be 0 V and actuator 202 is provided 15 V, which would attract shutter 206, while actuator 204 being at 0 V would repel shutter 206 since they are at the same voltage. Next, at time 410 in FIG. 4B, shutter 206 of shutter assembly 200 may be positioned closer to actuator 206 since node 365 is at 15 V, causing shutter 206 to be repelled by actuator 202 and attracted to actuator 204. At time 410 in FIG. 4B, shutter 206 may be positioned back towards actuator 202.

Though the preceding example has shutter 206 of shutter assembly 200 moving back-and-forth through its entire movement range, in some implementations, shutter 206 may start from a neutral position away from actuators 202 and 204. A potential difference can then be applied between shutter 206 and either actuator 204 or actuator 202, in order to generate a transient electric current

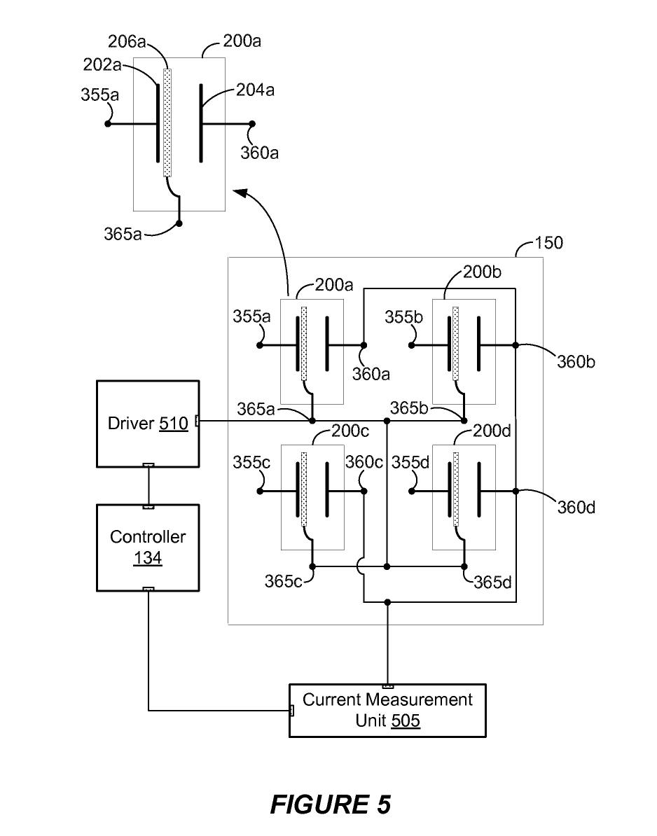

FIG. 5 shows a schematic diagram of an example capacitance change tracking circuit. In FIG. 5, the array of display elements 150 includes shutter assemblies 200a-d in a 2×2 arrangement of display elements, though any number and arrangement of shutter assemblies 200 may be used. Driver 510 may include a variety of circuitry to apply voltages to drive the array of display elements 150. For example, driver 510 may include data drivers 132, scan drivers 130, and common driver 138 of FIG. 1B. Controller 134 may provide data to data drivers 132, scan drivers 130, and common driver 138 of driver 510, as previously discussed regarding FIG. 1B. Current measurement unit 505 may determine a capacitance change of actuators of the array of display elements 150 by measuring a transient current pulse of the array of display elements 150 and storing the measurement as a capacitance measurement corresponding to the amount of residue on the actuators. When the capacitance changes such that it reaches a threshold capacitance, current measurement unit 505 may indicate to controller 134 that the capacitance has reached a threshold, and therefore, the operating parameters of the array of display elements 150 may be adjusted to account for the capacitance change due to the accumulated residue and to maintain a properly-functioning display.

For example, in FIG. 5, shutter assemblies 200a-d may have the electrodes associated with each corresponding shutter 206 provided a step voltage ranging from a low voltage to a high voltage by driver 510 at relatively the same time. Each of nodes 355a-d may be configured to be at a high voltage, for example, by the drive scheme implemented by controller 134 and display module 300. Each of nodes 360a-d also may be configured to be at a lower voltage. Accordingly, each actuator 202 (including actuator 202a in FIG. 5) of the shutter assemblies 200a-d may be at a high voltage (such as 15 V), each actuator 204 (including actuator 204a in FIG. 5) of the shutter assemblies 200a-d may be at a low voltage (such as 0 V), and each shutter 206 (including shutter 206a in FIG. 5) of the shutter assemblies 200a-d may be provided the step voltage (such as ranging from 0 V to 15 V), similar to the examples described in FIGS. 4A and 4B. As a result, driver 510 may provide the step voltage to nodes 365a-d such that shutters 206 of shutter assemblies 200a-200d may be positioned within their movement range between their corresponding actuators 202 and 204 so that a transient current pulse may be generated.

In particular, current measurement unit 505 in FIG. 5 may be coupled with nodes 360a-d (i.e., the nodes provided the low voltage) and may be able to measure the transient current pulse from nodes 360a-d as shutters 206 of shutter assemblies 200a-d are positioned. That is, current measurement unit 505 may measure the current of all of nodes 360a-d (i.e., the current from one of the electrodes associated with an actuator from every shutter assembly 200a-d) which may correspond to the buildup of residue of the actuators 202 or 204, and therefore, be used to determine whether the capacitance of the actuators of the array of display elements 150 has decreased due to the accumulation of residue. For example, the current from the electrode of an actuator of each shutter assembly 200a-d may be accumulated together to determine a peak current as an indirect measurement of capacitance, and therefore, the residue on the actuators. As a result, the peak current of the transient current pulse may be correlated with the capacitance, which also may be an estimate or indication of the accumulated residue on the actuators.

Though the preceding example applies a step voltage and measures the transient current pulse from an electrode of an actuator of each corresponding shutter assembly 200a-d of the array of display elements 150, any type of signal applied to and response measured from the array of display elements 150 may be used to indicate an accumulation of residue on the actuators. For example, any combination of electrical characteristics (such as voltage, current, etc.) may be applied to and measured from the array of display elements 150 and correlated with capacitance or the accumulation of residue on the actuators. Moreover, the capacitance change tracking circuit in FIG. 5 is just one example of a circuit for capacitance change tracking. Other implementations may include different circuitry to determine a change in capacitance.

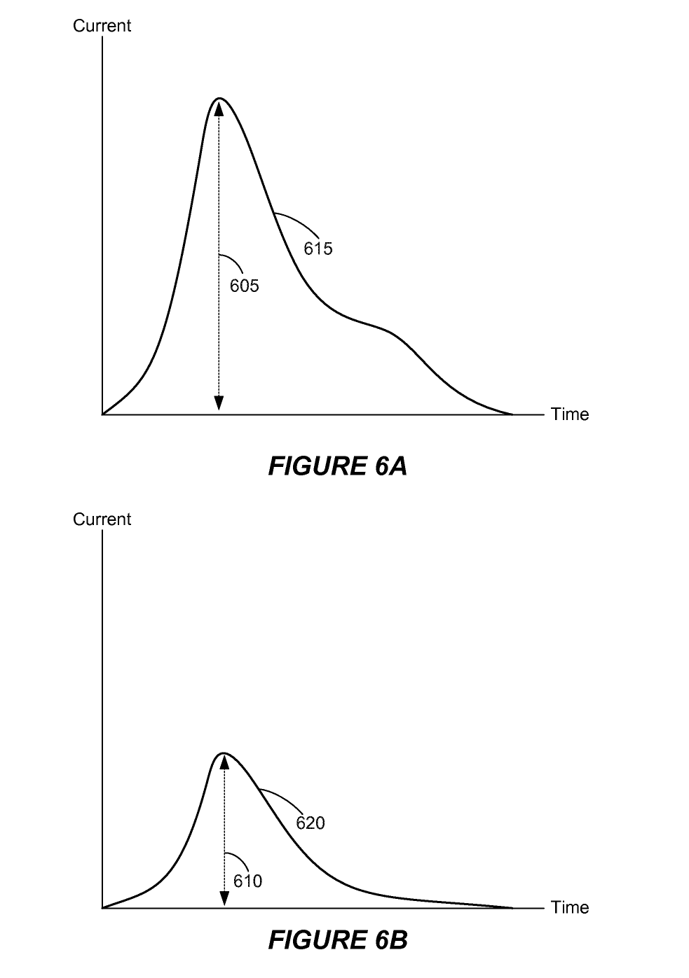

Current measurement unit 505 in FIG. 5 may perform multiple measurements of the transient current pulse over the lifetime of the array of display elements 150. FIGS. 6A and 6B show charts of examples of current measurements for capacitance change tracking. In FIG. 6A, current measurement unit 505 may measure the transient current pulse 615 and determine peak current 605 (i.e., the highest current during the duration of transient current pulse 615). The determination of peak current 605 may be stored as an indication of the capacitance and accumulation of residue on the actuators, or it may be used to determine (or calculate) a capacitance and store the determined capacitance as an indication of the accumulation of residue on the actuators. At a later time, current measurement unit 505 may measure the transient current pulse again. For example, driver 510 (including data drivers 132, scan drivers 130, and common driver 138 of FIG. 1B, as previously discussed) may provide the same step voltage (i.e., at the same length of time and the same magnitude of voltage) and transient current pulse 620 in FIG. 6B, may be generated and measured by current measurement unit 505. Peak current 610 of transient current pulse 620 in FIG. 6B is lower than peak current 605 of transient current pulse 615 in FIG. 6A because residue may have accumulated (or further accumulated) upon one or both of actuators 202 and 204, and therefore, the capacitance has decreased, as previously discussed. As a result, the peak current of the transient current pulse also decreases.

In some implementations, additional data other than peak currents 605 and 610 in FIGS. 6A and 6B, respectively, may be measured. For example, the width of the transient current pulse, the shape of the transient current pulse, when the peak current occurs, or other characteristics of transient current pulses may be measured and used to determine capacitance.

If the measurement indicates that the capacitance has decreased to a threshold capacitance (i.e., the capacitance has changed and lowered due to residue accumulating on an actuator), current measurement unit 505 in FIG. 5 may indicate to controller 134 that the operating parameters of the array of display elements 150 may need to be adjusted to maintain a properly-functioning display. For example, if the capacitance decreases to a particular threshold capacitance (and therefore indicates that a certain level of residue may have accumulated on actuators 202 or 204), then the voltages to be applied to one or more of nodes 355a-d, 360a-d, and 365a-d may need to be changed so that a stronger electric field may be generated across shutter assemblies 200a-200d to maintain the amount of force used to position shutters 206 within the allotted time. As a result, controller 134 may indicate to driver 510 to increase a voltage, or controller 134 may provide a higher voltage to driver 510. For example, the voltage applied to any of nodes 360a-d may be increased. In some implementations, the voltage applied to nodes 360a-d and 365a-d in FIG. 5 may be changed to increase the electric field between the respective nodes by decreasing or increasing the applied voltages. In some implementations, voltages applied to another combination of nodes may be changed, or the voltage of a single node may be changed. As another example, the time allotted to positioning shutters 206 may be increased while maintaining the same voltages applied to nodes 355a-d, 360a-d, and 365a-d (i.e., less force would be applied due to the lowering of the capacitance, which would result in shutters 206 needing more time to be positioned). As a result, controller 134 may increase the time between sending data to driver 510. For example, controller 134 may decrease a frequency of a clock used by driver 510. Accordingly, the performance or operation of the display may be derated over time. This may avoid having shutters that do not finish moving between positions during the allotted time, which might cause pixels to appear as either dark or bright artifacts on the display.

In some implementations, current measurement unit 505 may maintain a moving average of an indication of the capacitance of the actuators of the array of display elements 150. Accordingly, as each new measurement is made, the moving average may be updated, and when the moving average reaches a threshold value (such as indicating that the moving average has decreased such that a threshold capacitance has been reached), then the operating parameters may be changed.

In some implementations, controller 134 may poll current measurement unit 505 and receive an indication of the capacitance of the array of display elements 150 and then adjust the operating parameters if a threshold capacitance has been reached. In some implementations, controller 134 may read memory in current measurement 505 storing the measurements or the moving average and then make a determination as to whether the operating parameters need to be adjusted based on whether the indication of capacitance has reached a threshold.

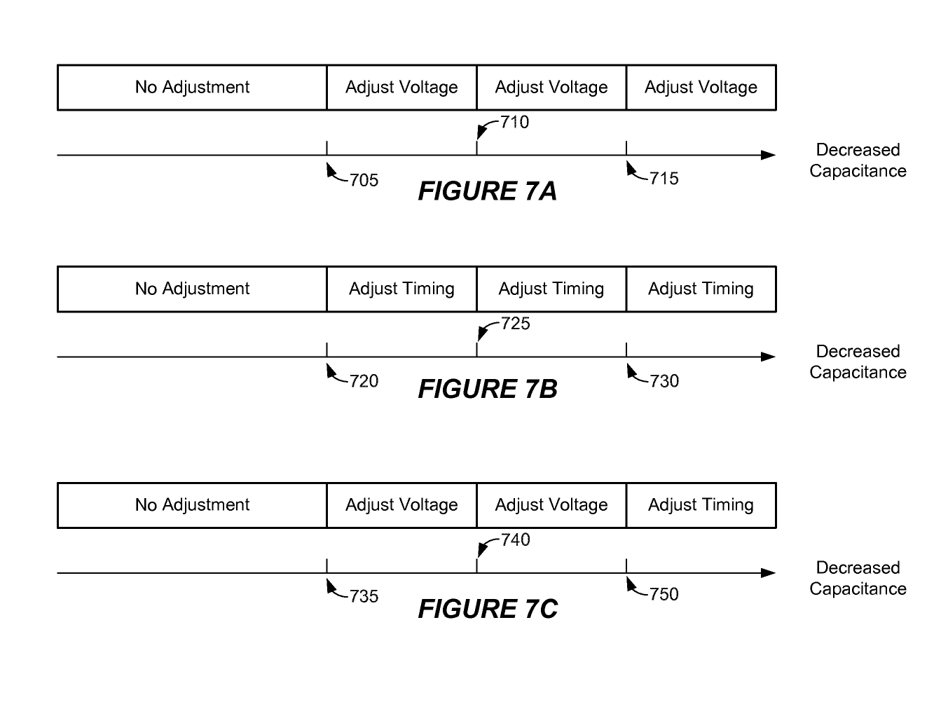

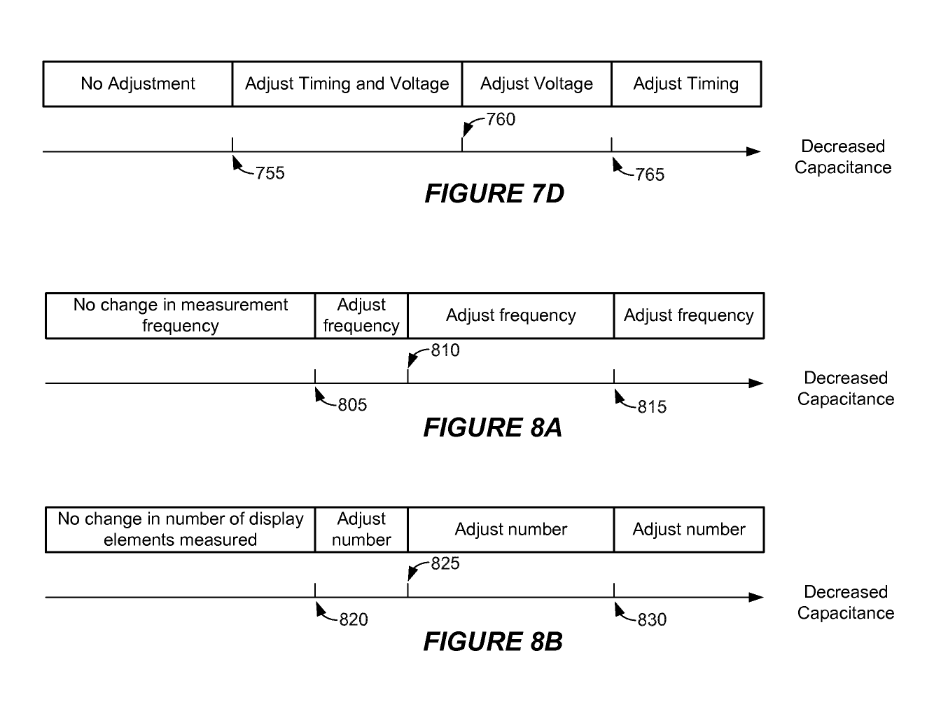

FIGS. 7A, 7B, 7C, and 7D show examples of adjusting operating parameters of a display element based on the capacitance change. In FIG. 7A, a voltage applied to nodes 355a-d, 360a-d, and 365a-d to drive electrodes of shutter assemblies 200a-d in FIG. 5 may be adjusted based on the measurement performed by current measurement circuit 505. In particular, as capacitance of an actuator (or the moving average of the capacitance) is decreased, the voltages applied to the electrodes of the display element may be adjusted in response to the decreased capacitance. In FIG. 7A, when the capacitance reaches capacitance 705, a first adjustment to the voltages may be performed. As the capacitance continues to decrease, no further adjustments may be made until capacitance 710. When the measured capacitance reaches or exceeds capacitance 710 for the first time, a second adjustment may be made, for example, by further increasing a voltage applied to an electrode, for example, by increasing the voltages applied to one or more of nodes 355a-d, 360a-d and 365a-d in FIG. 5. Likewise, an additional, third adjustment may be made when capacitance 715 is reached. The voltage adjustments may be made to ensure that shutter 206 may be positioned within its allotted time as the capacitance of the actuators decreases due to the accumulating residue, as previously discussed.

In FIG. 7B, the time allotted, or allocated, to positioning shutters 206 to new positions may be adjusted rather than a voltage applied to an electrode. For example, at capacitance 720, the timing may be adjusted, for example, by extending the allotted time from 100 microseconds (μs) to 150 μs. Likewise, when the capacitance decreases to capacitances 725 and 730, further adjustments to the timing (such as increasing the time allotted) may be performed. Adjusting the allotted time rather than voltage may allow for the same voltages to be applied to the electrodes of shutter assembly 200.

In FIG. 7C, as capacitance decreases, the voltage or timing may be adjusted at different times. For example, when capacitances 735 and 740 are reached, voltage may be adjusted. However, as capacitance 750 is reached, timing may be adjusted instead of voltage. As a result, as the capacitance decreases, a mix of adjusting voltage and timing may be performed.

In FIG. 7D, both voltage and timing may be adjusted when a threshold capacitance is reached. For example, when capacitance 755 is reached or exceeded for the first time, both the voltage and the allocated time may be adjusted. Next, at capacitance 760, the voltage may be adjusted, followed by adjusting the time allocated at capacitance 765.

The adjustments may be uniform (such as each adjustment increases the allotted time by 50 μs, or a 10% increase) or non-uniform (such as each adjustment increases the allotted time by a different amount or percentage).

The different operating parameter adjustment schemes of FIGS. 7A-D may be selected based on the usage of the display. For example, if the display is a television, bit-depth (i.e., the number of colors available) may be sacrificed by adjusting the timing rather than voltage. If bit-depth should be preserved, such as in higher-performance displays, then the voltage may be adjusted instead.

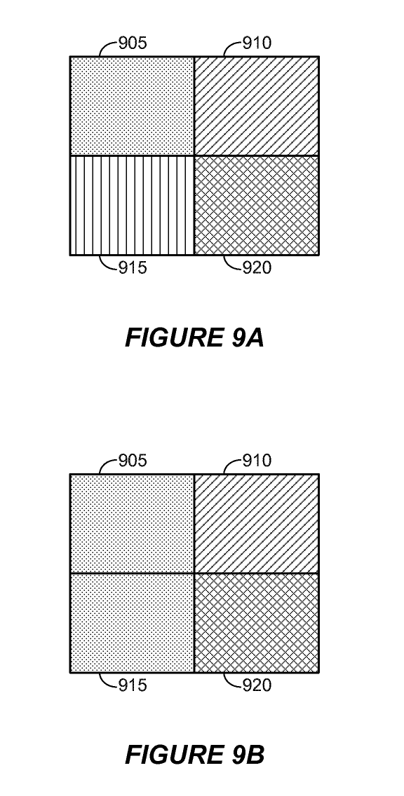

Additionally, operating parameters of the capacitance change tracking also may be adjusted. FIGS. 8A and 8B show examples of adjusting operating parameters of the capacitance change tracking based on the capacitance change. In FIG. 8A, the frequency of providing a step voltage pulse to nodes 365a-d and measuring the transient current pulse at nodes 360a-d in FIG. 5 may be adjusted. For example, as capacitance decreases, the frequency of circuit measurement unit 505 measuring the peak current of the transient current pulse (such as peak currents 605 or 610) may be increased or decreased. As an example, in FIG. 8A, as capacitance decreases and reaches capacitance 805, current measurement unit 505 may begin increasing the frequency of its current measurements. As capacitance continues to decrease (indicating further accumulation of residue on the actuators), the frequency may be further increased, for example, at capacitances 810 and 815.

In FIG. 8B, the number of display elements measured at a time by current measurement unit 505 in FIG. 5 also may be adjusted. As capacitance decreases, the number of display elements 300 measured that collectively provides the current for the transient current pulse may be increased or decreased. As an example, in FIG. 8B, the number of display elements measured at a time may be increased each time when the measured capacitance reaches thresholds corresponding to capacitances 820, 825, and 830. In some implementations, the number may be increased because, as depicted in FIGS. 6A and 6B, the peak current of the transient current pulse may decrease as capacitance decreases (as residue accumulates), and therefore, increasing the number may allow for a higher measured peak current which may provide a more accurate measurement of a capacitance change.

As another example, quadrants (or other types of portions) of the array of display elements 150 may be measured individually and have their operating parameters set at different values and adjusted separately. FIGS. 9A and 9B show examples of adjusting a number of display elements measured at a time. For example, in FIG. 9A, each quadrant 905, 910, 915, and 920 may include 100 display elements. Each of the quadrants may be measured separately, either by a single current measurement unit 505 in FIG. 5 measuring each quadrant one after another, or multiple current measurement units 505 with one for each quadrant. In FIG. 9A, the different shadings for each of quadrants 905, 910, 915, and 920 indicate that the quadrants are separately measured. When a particular quadrant (such as the top-left quadrant 905) is indicated as reaching a threshold capacitance similar to FIG. 8B, the number of display elements measured within the array of display elements 150 may be increased such that now an additional quadrant such as the bottom-left quadrant 915) may be included in the current measurements of current measurement unit 505 with quadrant 905, resulting in 200 display elements 150 rather than 100 display elements 150 being measured together. For example, in FIG. 9B, both quadrants 905 and 915 may be measured together when the number of display elements 150 measured at a time is to be increased. Additionally, the display elements in the two quadrants may be subject to the same operating parameter adjustments. However, the other two quadrants (such as the top-right 910 and bottom-right 920) may have different operating parameter adjustments and may still be measured separately and separately measure 100 display elements 150.

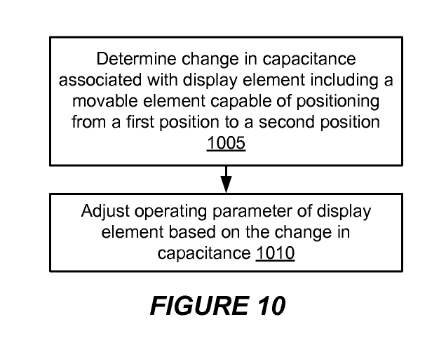

FIG. 10 shows a flowchart of an example process flow for adjusting operating parameters of a display element based on a change in capacitance. At block 1005, a change in capacitance associated with a display element including a movable element capable of positioning from a first position to a second position can be determined. For example, an actuator of a display element may decrease in capacitance and reach a threshold capacitance. In some implementations, the capacitance can be determined by applying a signal (such as a step voltage) to an electrode of the display element. The application of the signal may cause a movable element of the display element to move within its movement range. As the movable element moves within its movement range, a response of the display element to the signal causing the movement may be determined (such as determining a peak current of a transient current pulse generated by the step voltage). The response may be correlated with a capacitance of an actuator of the display element that may be used to position the movable element.

At block 1010, an operating parameter of the display element may be adjusted based on the change in capacitance. For example, a voltage applied to one or more electrodes of the display element may be changed to increase the electric field between electrodes, resulting in a stronger electric field to generate enough force to move the movable element. As another example, timing considerations (such as an allocated time for positioning the movable element from a first position to a second position) of the display element may be adjusted to account for the capacitance change. In some implementations, operating parameters of the capacitance change tracking also may be adjusted. For example, a frequency of determining the capacitance change or the number of display elements measured at a time may be changed in response to the measured capacitance.

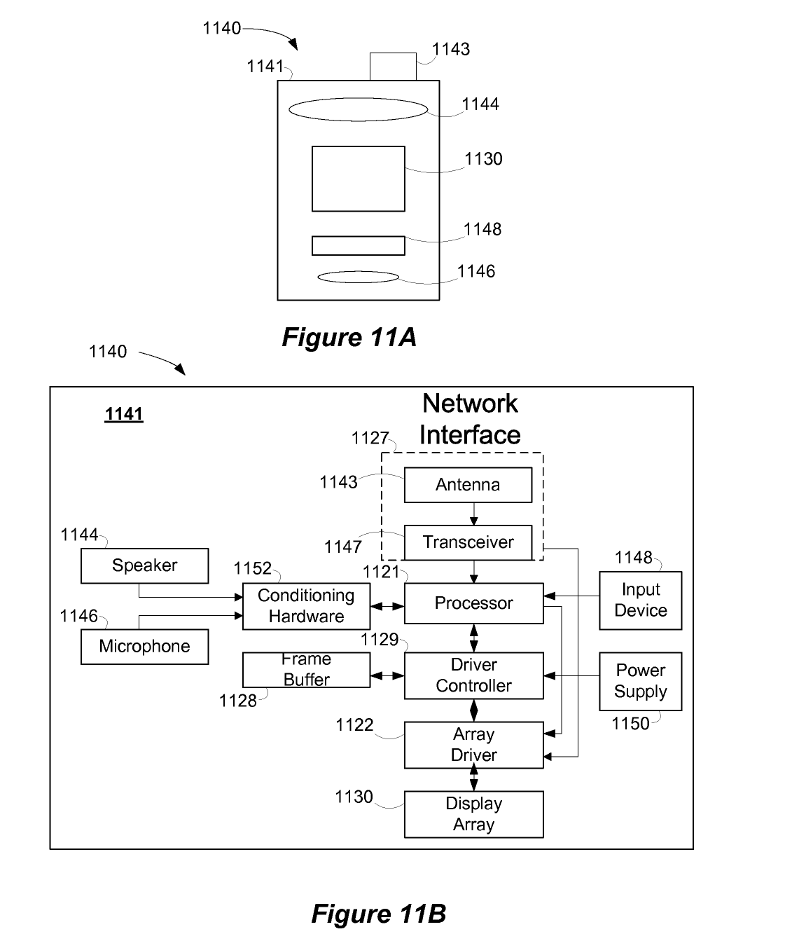

FIGS. 11A and 11B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 11B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 11A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A circuit capable of determining a capacitance change associated with a display element including a movable element capable of positioning from a first position to a second position, and the circuit further capable of adjusting an operating parameter of the display element based on the capacitance change, adjusting the operating parameter of the display element including one or both of: adjusting an allocated time for the movable element to position from the first position to the second position, and adjusting a voltage applied to an electrode of the display element.

2. The circuit of claim 1, wherein adjusting the voltage applied to the electrode of the display element increases an amount of force used to position the movable element from the first position to the second position.

3. The circuit of claim 2, wherein the increase in the amount of force used to position the movable element from the first position to the second position is capable of positioning the movable element from the first position to the second position within the allocated time.

4. The circuit of claim 1, wherein the circuit is further capable of providing a signal to the display element, and the capacitance change is determined based on a response of the display element to the signal.

5. The circuit of claim 4, wherein the signal is a step voltage applied to a first electrode of the display element, and the response is a transient current pulse associated with a second electrode of the display element.

6. The circuit of claim 1, wherein the capacitance change indicates that a capacitance associated with an actuator of the display element has decreased to a threshold value.

7. The circuit of claim 1, wherein the circuit is further capable of adjusting a frequency of determining the capacitance change based on the capacitance change.

8. The circuit of claim 1, wherein the capacitance change is associated with an accumulation of residue on an actuator of the display element.

9. The circuit of claim 1, further comprising:
a display including the display element;
a processor capable of communicating with the display, the processor being capable of processing image data; and
a memory device capable of communicating with the processor.

10. The circuit of claim 9, further comprising:
a driver circuit capable of sending at least one signal to the display; and
a controller capable of sending at least a portion of the image data to the driver circuit.

11. The circuit of claim 9, further comprising:
an image source module capable of sending the image data to the processor, wherein the image source module includes at least one of a receiver, transceiver, and transmitter.

12. The circuit of claim 9, further comprising:
an input device capable of receiving input data and communicating the input data to the processor.

13. A display comprising:
an array of display elements, each display element in the array of display elements including a movable element capable of being positioned by an actuator;
a capacitance change unit capable of determining a change in capacitance associated with the actuators; and
a controller capable of adjusting an operating parameter of the array of display elements based on the change in capacitance, adjusting the operating parameter of the display elements including one or both of: adjusting an allocated time for the movable elements to position from the first position to the second position, and adjusting a voltage applied to electrodes of the display elements.

14. The display of claim 13, wherein adjusting the voltage applied to the electrodes of the display elements increases an amount of force used to position the movable elements from the first position to the second position.

15. The display of claim 14, wherein the increase in the amount of force used to position the movable elements from the first position to the second position is capable of positioning the movable elements from the first position to the second position within the allocated time.

16. The display of claim 13, wherein each display element in the array of display elements includes a first electrode and a second electrode, and wherein the change in capacitance is determined based on a signal applied to the first electrode of each display element and a response measured from the second electrode of each display element.

17. A method comprising:
determining a change in capacitance associated with a display element including a movable element capable of positioning from a first position to a second position; and
adjusting an operating parameter of the display element based on the change in capacitance, adjusting the operating parameter of the display element including one or both of: adjusting an allocated time for the movable element to position from the first position to the second position, and adjusting a voltage applied to an electrode of the display element.

18. The method of claim 17, wherein adjusting the voltage applied to the electrode of the display element increases an amount of force used to position the movable element from the first position to the second position.

19. The method of claim 18, wherein the increase in the amount of force used to position the movable element from the first position to the second position is capable of positioning the movable element from the first position to the second position within the allocated time.

20. The method of claim 17, further comprising:
applying a signal to a first electrode of the display element, and wherein determining the change in capacitance is based on a response of a second electrode of the display element to the signal.
